(19) United States
(12) Patent Application Publication
(10) Pub. No.: US 2014/0302249 A1
(43) Pub. Date: Oct. 9, 2014

(54) COATED FIBERS EXHIBITING BEADS-ON-A-STRING MORPHOLOGY

(71) Applicants: Ali Dhinojwala, Akron, OH (US); Vasav Sahni, Akron, OH (US); Disha Vinod Labhasetwar, Solon, OH (US)

(72) Inventors: Ali Dhinojwala, Akron, OH (US); Vasav Sahni, Akron, OH (US); Disha Vinod Labhasetwar, Solon, OH (US)

(73) Assignee: THE UNIVERSITY OF AKRON, Akron, OH (US)

(21) Appl. No.: 14/342,055

(22) PCT Filed: Aug. 31, 2012
(86) PCT No.: PCT/US2012/053460

§ 371 Date: Apr. 21, 2014

Related U.S. Application Data
(60) Provisional application No. 61/529,483, filed on Aug. 31, 2011.

(51) Int. Cl. C09J 183/04

(52) U.S. Cl. CPC C09J 183/04
USPC 427/501; 427/207.1; 427/510

(57) ABSTRACT

A method of preparing a fiber with periodically spaced beads includes the steps of: coating a base fiber with a settable coating; thereafter allowing the settable coating to form periodically spaced beads on the base fiber; and stabilizing the periodically spaced beads into periodically spaced beads thus creating a fiber with beads-on-a-string morphology.

### CROSS-REFERENCE TO RELATED APPLICATIONS

This application claims priority from International Application No. PCT/US2012/053460 filed Aug. 31, 2012 which claims priority from U.S. Provisional Application No. 61/529,483 filed on Aug. 31, 2011, the contents of which are incorporated herein by reference.

### FIELD OF THE INVENTION

The present invention generally relates to fibers and more particularly to fibers exhibiting beads-on-a-string morphology. This invention also relates to methods for creating fibers with such morphology. In a particular embodiment, this invention relates to an adhesive fiber wherein the adhesive property is improved by such morphology.

### BACKGROUND OF THE INVENTION

Spiders display innovative behavioral strategies in conjunction with micron-size custom-made adhesive silk threads incorporated into prey capture webs. The proteins as well as low-molecular-mass organic and inorganic materials used in these webs evolved over millions of years into a class of natural adhesives with outstanding properties. Multiple types of adhesives are often used in a single spider web; however, the adhesives used to capture prey have yet to be thoroughly understood. Silk threads spun by modern orb-weaving spiders to capture prey consist of a beads-on-a-string (BOAS)-like morphology, where the beads of glue are composed of adhesive polymeric glycoproteins and low-molecular-weight hygroscopic compounds. The string is comprised of a pair of soft and highly extensible viscoelastic axial silk fibers. The BOAS threads are produced from triads of spigots that lie on the posterior spinnerets of spiders. Each triad is composed of a gland that produces an axial silk fiber (flagelliform gland), two glands which secrete glue (aggregate gland) and their respective spigots. The spigot from the fiber gland is arranged between the spigots of the glue glands such that the glue and fibers are simultaneously extruded and glue coats the fiber. The composition of the glue, its physical characteristics and the spinning conditions of the silk produce an initially cylindrical coating of the glue on the axial silk which breaks down into an equally-spaced micron-sized array of glue droplets due to Rayleigh instability. After a period of time, the glue droplets become more viscous and develop elasticity, which become important in enhancing adhesion.

Interestingly, even though Rayleigh instability results in reducing the surface area of the adhesive coating, the BOAS structure is prevalent. In addition, the BOAS thread is more visible than the cylindrical thread, which is an undesirable characteristic in a trap. The success of BOAS morphology is also evident through other examples, especially by its presence in the gumfoot silk threads spun by the cobweb-weaving spiders, the evolutionary descendents of modern orb-weaving spiders.

Though this BOAS phenomenon occurs in nature, the art would benefit from methods to mimic this phenomenon in the creation of new fibers. Notably, “fibers” and “threads” are generally defined similarly, and, though “thread” has been used in disclosing the morphology of spider web components, the term “fiber” will be employed herein for disclosing this invention.

### SUMMARY OF THE INVENTION

Embodiment 1: This invention provides a method of preparing a fiber with periodically spaced beads comprising: coating a base fiber with a settable coating; thereafter allowing the settable coating to form periodically spaced beads on the base fiber through Rayleigh instability; and stabilizing the periodically spaced beads into periodically spaced beads thus creating a fiber with beads-on-a-string morphology.

Embodiment 2: This invention provides a method as in Embodiment 1, wherein either the base fiber or the settable coating is non-proteinaceous.

Embodiment 3: This invention provides a method as in Embodiments 1 or 2, wherein the settable coating is selected from coatings that are stabilized through curing, coatings that are stabilized through drying, and coatings that are stabilized through cooling.

Embodiment 4: This invention provides a method as in any of Embodiments 1 through 3, wherein the settable coating is a coating that is stabilized through curing, and said step of stabilizing includes at least partially curing said settable coating.

Embodiment 5: This invention provides a method as in any of Embodiments 1 through 4, wherein the settable coating is selected from coatings that are UV curable, coatings that are heat curable, coatings that are electron beam curable and coatings that are curable through use of one or more chemicals or catalysts.

Embodiment 6: This invention provides a method as in any of Embodiments 1 through 5, wherein said settable coating is a coating that is stabilized through drying, and said step of stabilizing includes drying said settable coating.

Embodiment 7: This invention provides a method as in any of Embodiments 1 through 6, wherein said settable coating is a solvent/solute system, and said step of stabilizing includes evaporating the solvent to stabilize the settable coating.

Embodiment 8: This invention provides a method as in any of Embodiments 1 through 7, wherein the settable coating is a coating that is stabilized through cooling, and said step of stabilizing includes cooling said settable coating.

Embodiment 9: This invention provides a method as in any of Embodiments 1 through 8, wherein said settable coating is an amorphous or semi-crystalline material having a reversible glass transition temperature, and said step of stabilizing includes reducing the temperature of the settable coating below the glass transition temperature.

Embodiment 10: This invention provides a method as in any of Embodiments 1 through 9, wherein said step of coating a base fiber includes drawing the base fiber out of a bulk source of settable coating at a velocity, V.

Embodiment 11: This invention provides a method as in any of Embodiments 1 through 10, wherein the settable coating includes a viscosity, η, and a surface tension, γ, wherein a capillary number, Ca is calculated according to Ca=ηV/γ.

Embodiment 12: This invention provides a method as in any of Embodiments 1 through 11, wherein the velocity, V, of said step of coating and the settable coating are chosen such that Ca is approximately 1.

Embodiment 13: This invention provides a method as in any of Embodiments 1 through 12, wherein the velocity, V, of said step of coating and the settable coating are chosen such that Ca is less than 1.

Embodiment 14: This invention provides a method as in any of Embodiments 1 through 13, wherein the velocity, V, of said step of coating and the settable coating are chosen such that Ca is equal to or less than 0.64.

Embodiment 15: This invention provides a method as in any of Embodiments 1 through 14, wherein, in said step of coating, the settable coating forms an initially cylindrical coating on the base fiber, and wherein the size and spacing of the periodically spaced beads that form in said step of allowing are determined according to the following formulae:

$$\begin{matrix}e = \{ \begin{matrix}1.34 {dCa}^{2 / 3} , & Ca ≪ 1 \\ \frac{1.34 {dCa}^{2 / 3}}{1 - 1.34 {Ca}^{2 / 3}} , & Ca \sim 1 ,\end{matrix} & ( 1 ) \\ λ > 2 π ( d + e ) , \\ and & ( 2 ) \\ R = {[ \frac{3 λ}{4} ( {( d + e )}^{2} - {d}^{2} ) ]}^{1 / 3} & ( 3 )\end{matrix}$$

wherein d is the radius of the base fiber, e is the thickness of the initially cylindrical coating on the base fiber and R is the radius of the beads and λ is the wavelength of the periodically spaced beads, and Ca<<1 is to be understood as indicating that Ca is equal to or less than 0.64 and Ca≈1 is Ca greater than 0.64.

Embodiment 16: This invention provides a method as in any of Embodiments 1 through 15, wherein the settable coating has a bond number of less than 1.

### BRIEF DESCRIPTION OF THE DRAWINGS

FIG. 1 is a general representation of a BOAS fiber in accordance with this invention, wherein the beads on the base fiber do not form a continuous coating of the base fiber.

FIG. 2 is a general representation of a BOAS fiber in accordance with this invention where the bead formation is such that the base fiber still contains a continuous coating.

FIG. 3 is a schematic representation of an apparatus for creating BOAS fibers in accordance with this invention.

FIG. 4 is a schematic representation of an apparatus for testing adhesion force of the BOAS fibers.

FIG. 5(a) is a photograph of the suspension bridge structure formed when a capture silk thread spun by Larinioides cornutus is separated from a glass surface.

FIG. 5(b) is a photograph of the suspension bridge structure formed when a nylon fiber coated with beads of PDMS is separated from a glass surface.

FIG. 5(c) shows the adhesion force of a BOAS fiber (PDMS-coated nylon) as a function of the capillary number (rate of separation of thread from the substrate=2 mm·s−1).

FIG. 5(d) shows the effect of capillary number on the adhesion energy of the PDMS beads of the PDMS-coated nylon.

FIG. 6 is a graph of the contact area established on glass by a cylindrical coated fiber and a BOAS fiber having equal volumes of cylindrical coating and BOAS coating, calculated assuming JKR theory, which is applicable here since the nylon fiber is coated with PDMS (Sylgard 528 A and B), which, after cross-linking, becomes elastic. The volumes of the cylinders and spheres were calculated using volume conservation on the dimensions of the glue drops on the capture spiral threads spun by Cyclosa turbinata (circles), Leucauge venusta (squares), Metepeira labyrynthia (upright triangle), Araneus pegnia (inverted triangle), Argiope trifasciata (left triangle), and Araneus marmoreus (right triangle). Filled symbols represent spheres, whereas the corresponding open symbols represent cylinders. Spheres establish higher contact area than cylinders for the same loading force. Inset compares the adhesion of freshly spun capture threads (the coating is still cylindrical) (hashed bars) versus capture threads in which the coating has BOAS structure (solid bars), at different rates of pull-off (speed at which the thread is separated from the substrate). Glue droplets cause the capture threads to adhere many times stronger than the cylindrical glue coating.

FIG. 7 shows a typical force-displacement curve obtained from the NanoBionix (FIG. 4) during an adhesion measurement. The curve produced by circles shows the load as the thread is brought into contact with the clean glass plate at 0.1 mm s⁻¹ to a force of 20 μN (Inset i). The thread is held there for 60 seconds during which a part of the force relaxes, as is shown by the vertical black line. (During these 60 seconds, the force relaxation achieves a plateau in all the cases shown in this work). The thread is then pulled back at a fixed rate (2 mm s⁻¹ in this case) from the glass plate as is shown by the curve produced by squares. The thread reaches its original, unstrained position, ii (Inset ii), after which it is retracted from the glass plate at the same fixed rate, as is shown by the curve produced by triangles (without a break). The thread eventually releases contact at iii (Inset iii), during which the force registered is called the pull-off force. The total work done, WT (Equation 4), is calculated when the thread is past point ii (area under the triangle produced curve).

FIG. 8 shows a typical tensile test performed to find the strain energy contribution _{UStrain,} as described in Equation 5. To ensure no ‘memory effect’ during stretching, the thread (Nylon+PDMS, 16 mm original length) is pre-stretched to 20 μN (red curve) to mimic the pre-loading during adhesion measurements. The thread is then allowed to relax for 60 seconds, after which it is brought to its original unstretched length to mimic going inset i to inset ii in FIG. 7. Finally, the thread is stretched till it equals its maximum length achieved in adhesion measurements. To account for viscoelastic effects, rates of stretching during tensile measurements are kept identical to the rates experienced by threads during adhesion measurements. The curve produced by circles is obtained at 16 μm/s, curve produced by squares at −330 μm/s (unloading), and curve curve produced by triangles at 330 μm/s. U_{Strain} is obtained by integrating the area under the green curve. The inset in FIG. 8 explains the whole process schematically. Arrowheads indicate stretching, inverted arrowheads denote bringing back to the original length, while circular caps denote no stretching. The differences in lengths of the segments shown in the schematic are exaggerated for clarity.

FIG. 9(a) shows a capture spiral thread spun by Argiope trifasciata (scale bar is 30 μm).

FIG. 9(b) shows a BOAS fiber produced by withdrawing a nylon thread out of a reservoir filled with PDMS.

FIG. 9(c) shows the effect that the velocity at which the nylon thread is pulled through the PDMS coating has on the bead dimensions when nylon threads are coated with PDMS of kinematic viscosity 1000 cst at velocities of 690, 2460, and 9460 μm·s⁻¹ (left to right).

FIG. 9(d) shows the Effect of PDMS viscosity on bead dimensions. Nylon threads are coated, at 9460 μm·s⁻¹, with PDMS of kinematic viscosities 10, 100, and 1000 cst (left to right). Capillary number increases from left to right. Scale bars in c and d are 150 and 50 μm, respectively.

### DETAILED DESCRIPTION OF ILLUSTRATIVE EMBODIMENTS

This invention relates to the preparation of fibers with periodically spaced beads, i.e., with beads-on-a-string (BOAS) morphology. In particular, this invention provides methods for coating a fiber and permitting the coating to form into an array of droplets (or beads on a string), thereafter locking those droplets in place by what is termed herein a “stabilizing” step, which may involve curing, drying, cooling or other practices that stabilize the BOAS morphology. The formation of the BOAS morphology occurs according to properties of the fiber and coating, and, with due attention to the selection of the fiber and coating, one may purposefully design a BOAS fiber with a desired size and spacing of beads.

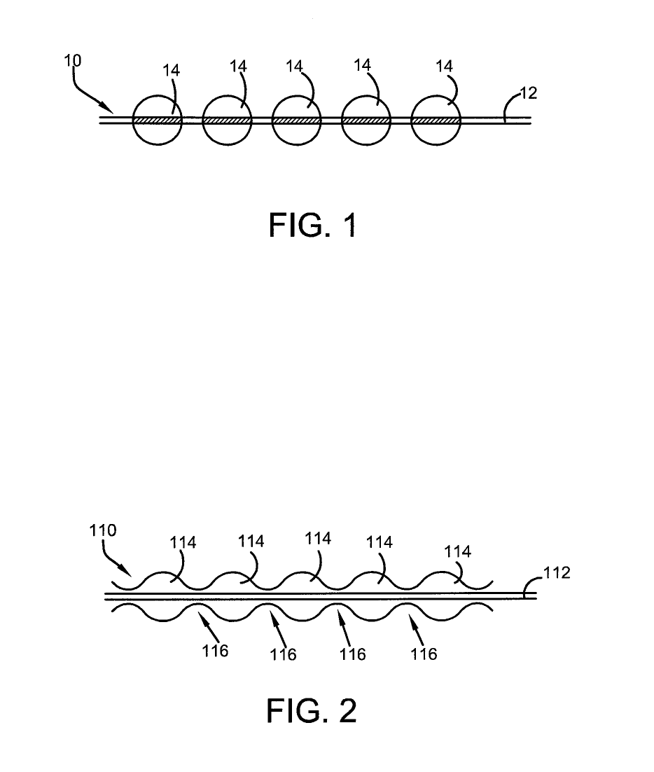

Fibers with periodically spaced beads can be referred to as beads-on-a-string fibers, fibers with a bead-on-a-string morphology, or BOAS fibers. They are multi-component structures comprising a base fiber and a coating, which is formed into beads. These beads, originating from a continuous relatively cylindrical coating, may be separate and distinct and no longer provide a continuous coating of the base fiber, as seen in FIG. 1, wherein a BOAS fiber 10 includes a base fiber 12 having separate and distinct beads 14. In other embodiments, the beads may also retain the continuous coating of the base fiber, as shown in FIG. 2, wherein a BOAS fiber 110 includes a base fiber 112 having a thin drawn out coating over the length of the base fiber 112, but with definite periodic bead formations, such as beads 114 joined by a thin layer of the coating, as at bridges 116.

BOAS fibers provide advantageous properties as compared to continuously coated fibers, which can be referred to as cylindrically coated fibers. The BOAS morphology allows for a greater degree of variability of contact area between the BOAS fiber and a substrate, as compared to a cylindrically coated fiber with an identical amount of coating per length of fiber. In general, BOAS fibers with a softer bead will provide a larger contact area between the BOAS fiber and the substrate, and a harder bead will provide a smaller contact area between the BOAS fiber and the substrate. The hardness or softness of the bead may be tailored during the stabilization step. For example, if curing the coating to stabilize the BOAS morphology, the degree of curing can be selected to achieve a desired hardness or softness.

If cooling the coating below its crystalline or glass transition temperature to stabilize the beads, the glass transition temperature of the coating and/or the temperature at which the fiber is employed may be selected to achieve a desired hardness or softness. The evaporation and drying of solvent can also be used to stabilize the bead structure.

The BOAS fibers are made by first coating a base fiber with a settable coating. This initially creates a cylindrically coated fiber, but the settable coating begins to form into beads on the base fiber as a result of Rayleigh instability (also known as Plateau-Rayleigh instability). As used herein, the term “settable” coating is to be understood as a coating that includes an initial state that will exhibit and undergo Rayleigh instability thus forming the BOAS morphologies as generally noted in FIGS. 1 and 2, and can be stabilized in a stabilizing step to establish a stabilized BOAS state (BOAS morphology). Thus, the base fiber is first coated with a settable coating, which is permitted to establish a BOAS morphology on the base fiber, thereafter being set into that morphology through a stabilizing step.

The base fiber may be selected from virtually any fiber that can survive the conditions used to stabilize the settable coating. Exemplary base fibers may be selected from the group consisting of natural fibers and synthetic fibers.

In one or more embodiments, the base fiber is a natural fiber selected from the group consisting of vegetable fibers and animal fibers. In one or more embodiments, the base fiber is a natural fiber selected from cellulose, cotton, jute, keratin, wool, and silk.

In one or more embodiments, the base fiber is a synthetic fiber selected from the group consisting of synthetic cellulose fibers, mineral fibers and polymer fibers. In one or more embodiments, the base fiber is a polymer fiber selected from the group consisting of acrylic fibers, modacrylic fibers, aramid fibers, para-aramid fibers, polyester fibers, copolymer fibers, polyvinyl alcohol fibers, polyvinyl chloride fibers, nylon fibers, polyurethane fibers, polyolefin fibers, polyoxazole fibers and crosslinked elastomer fibers. In one or more embodiments, the base fiber is a mineral fiber selected from the group consisting of glass fibers, carbon fibers, basalt fibers and metallic fibers. Metallic fibers may include, without limitation, metal, plastic-coated metal, metal-coated plastic, or a core completely covered by metal

In one or more embodiments, the base fiber to be coated is non-proteinaceous, while the settable coating may be proteinaceous. While the proteinaceous fiber produced by spiders exhibits good tensile strength and elasticity, the ability to extract large quanities of proteinaceous fiber from spiders is not currently available to produce enough proteinaceous fiber to have industrial applicability.

In one or more embodiments, base fibers can have diameters from 50 nm or more to 2 mm or less. In other embodiments, base fibers can have diameters from 100 nm or more to 1 mm or less, in other embodiments, from 100 nm or more to 0.5 mm or less, and in other embodiments, from about 100 nm or more to about 100 μm or less.

Although relatively short BOAS fibers can be prepared in accordance with this invention, it is noted that continuous methods disclosed herein can be employed to create very long, continuous BOAS fibers that can thereafter be cut to desired lengths.

The settable coating may be selected to be any material capable of flowing to coat the base fiber. The settable coating will typically be a fluid or flowable polymer having a low surface tension so that the bead formation of the settable coating is not appreciably affected by gravity. In particular embodiments wherein the base fiber coated with the settable coating is pulled vertically and the settable coating is stabilized, the settable coating has a bond number of less than 1.

In one or more embodiments, the settable coating is selected from coatings that are stabilized through curing, coatings that are stabilized through drying, coatings that are stabilized through cooling and coatings that are stabilized through polymerization.

In one or more embodiments, the settable coating is selected from coatings that are UV curable, coatings that are heat curable, coatings that are electron beam curable and coatings that are curable through use of one or more chemicals or catalysts. Those of ordinary skill in the art will know how to choose appropriate UV curable coatings, heat curable coating, electron beam curable coatings and coatings curable through the use of chemicals or catalysts. In one or more embodiments, when curing is imparted by ultraviolet radiation the UV curable coating may contain photo initiators.

In one or more embodiments, the settable coating is a solution (solvent/solute system), and the solvent is driven off to stabilize the BOAS morphology. This is a stabilization through drying.

In one or more embodiments, the settable coating is an amorphous or semi-crystalline material having a reversible glass transition temperature, wherein the coating is brought below the glass transition temperature to set the BOAS morphology. This is a stabilization through cooling.

In one or more embodiments, the settable coating includes monomers that can be stabilized through polymerization. In one or more embodiments, the settable coating includes monomer in a solvent. The monomer is polymerized to stabilize the coating. Methods of polymerizing monomers in the periodically spaced droplets includes, but is not limited to, the use of a catalyst, such as a coordination catalyst, a free radical initiator, a photo initiator, acid catalysts and bacterial enzymes

In one or more embodiments, the settable coating may be selected from siloxanes, urethanes, acrylates, natural rubber, styrene-butadiene rubber, EPDM rubber, and the like. In one or more embodiments, the settable coating is non-proteinaceous, while the base fiber may be proteinaceous. Thus, in one or more embodiments, either the base fiber or the settable coating is non-proteinaceous.

In one or more embodiments, the settable coating may include function additives chosen so as to provide functionality to the beads of the BOAS fiber. Functional additives may be chosen to impart water stability, adhesion, wear resistance, wettability, strength, drug delivery, antimicrobial, antifungal, anti-slip and high shear adhesion properties. Functional additives may be selected from the group consisting of pharmaceutical compounds, medicinal drugs, nanoparticles, adhesives, wound healing compounds, antibiotics, and antibacterial materials.

In one or more embodiments, an additive may be added to increase the viscosity of a coating. Viscosity increasing additives may be useful when a BOAS fiber with larger, less densely packed beads is desired. Examples of additives that will increase the viscosity of a coating include but are not limited to thickening agents such as starches, vegetable gums, pectins and proteins. In these and other embodiments, viscosity may be increased by selecting polymers of a higher molecular weight. In other embodiments, an additive may be added to decrease the viscosity of a coating. Viscosity decreasing additives may be useful when a BOAS fiber with smaller, more densely packed beads is desired. Examples of additives that can be used to decrease the viscosity of the settable coating include but are not limited to, plasticizers.

The BOAS fibers of this invention are made by first coating a base fiber with a settable coating, thereafter permitting the settable coating to form a BOAS morphology due to Rayleigh instability, and then stabilizing the BOAS morphology.

In one or more embodiments, the base fiber is coated with the settable coating by pulling the base fiber through a volume of settable coating. In accordance with this method, the base fiber and settable coating may be chosen to provide a desired BOAS morphology, meaning that the size and spacing of the beads can be predicted and thus achieved. The size and spacing of the beads are dependent upon the radius of the base fiber and the capillary number (Ca), wherein Ca is calculated according to the formula Ca=ηV/γ, wherein η is the viscosity of the settable coating, γ is the surface tension of the settable coating, and V is the velocity at which the fiber is drawn through the settable coating.

First, it should be appreciated that the settable coating will initially create a cylindrical coating on the base fiber. The thickness of this cylindrical coating will is designated as “e”, and, for bond number <<1 (which is the case here), e is given by the following equations:

$$e = \{ \begin{matrix}1.34 {dCa}^{2 / 3} , & Ca ≪ 1 \\ \frac{1.34 {dCa}^{2 / 3}}{1 - 1.34 {Ca}^{2 / 3}} , & Ca \sim 1 ,\end{matrix} \qquad ( 1 )$$

wherein d is the radius of the base fiber, Ca<<1 is to be understood as indicating that Ca is equal to or less than 0.64 and Ca≈1 is Ca greater than 0.64 The initially cylindrical coating breaks into an array of drops such that the wavelength of the array, λ, as well as the radius of the sphere, R, are both dependent on the thickness of the cylindrical coating e.

$$\begin{matrix}λ > 2 π ( d + e ) & ( 2 ) \\ R = {[ \frac{3 λ}{4} ( {( d + e )}^{2} - {d}^{2} ) ]}^{1 / 3} & ( 3 )\end{matrix}$$

Thus, by varying η, γ, or V, one can change Ca. Changing Ca will change the thickness of the coating and hence the radius of the cylinder, which will determine the wavelength λ of the array of spheres of radius R.

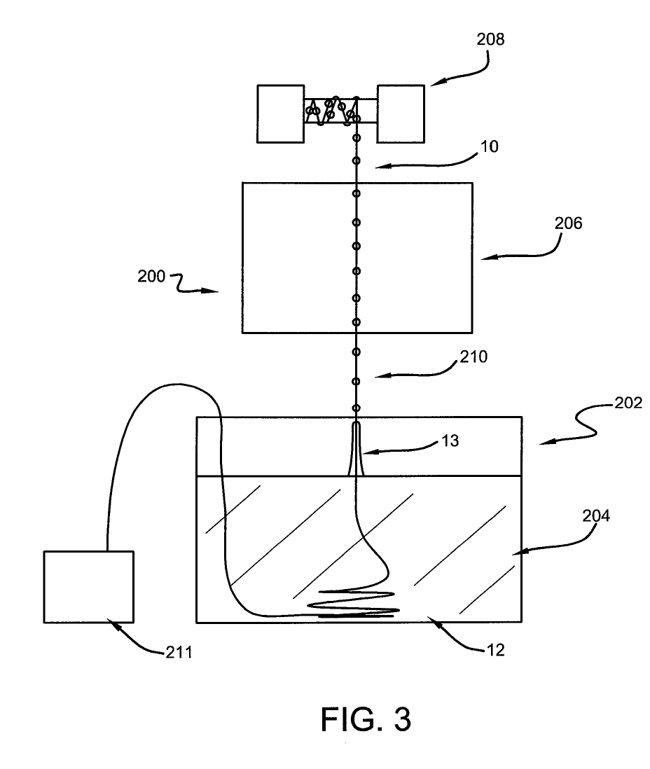

In one or more embodiment, the fiber is coated according to coating apparatus 200 as seen in FIG. 3. Coating apparatus 200 includes a spool 208, to which is secured a first end of a base fiber 12 so as to pull a length of the base fiber 12 through a reservoir 202 that contains a settable coating 204. A continuous BOAS fiber is produced by placing a base fiber 12 in or otherwise drawing a base fiber 12 through reservoir 202 (performed by the spool 208 in FIG. 3) so that the outer surface of the base fiber 12 is covered by settable coating 204. The base fiber 12 is shown as originating from a base fiber source 211. The base fiber source 211 may be a source of prefabricated base fiber (e.g., purchased or otherwise pre-obtained) or may be a source for production of the base fiber, such that the base fiber could be produced at the base fiber source and directly conveyed to the reservoir in a continuous process. Upon pulling base fiber 12 out of the settable coating 204 the settable coating initially creates a cylindrical coating on the base fiber, providing a cylindrical coated fiber 13. Due to Rayleigh instability, the settable coating of the cylindrical coated fiber 13 begins to form into unstabilized beads thus providing an unstabilized BOAS fiber, as represented at 210. It will be appreciated that forming the desired unstabilized BOAS fiber morphology may take time, and adequate time will be accounted for by the timing of the removal of the base fiber from the reservoir and the beginning of the stabilizing step, which is next disclosed.

The unstabilized BOAS fiber 210 is passed through a stabilizing area 206. In one or more embodiments, when the BOAS fiber 10 exits the stabilizing area 206 the beads are completely stabilized. In other embodiments, particularly when softer beads are desired, when the BOAS fiber 10 exits the stabilizing area 206, the beads may be partially stabilized or less that fully stabilized.

The stabilizing area 206 may stabilize the droplets by, for example, curing, drying, cooling and combinations thereof. For example, in one embodiment, when the settable coating 204 is heat curable, stabilizing area 206 may be an oven that subjects the heat curable coating to heat. In another embodiment, when the settable coating 204 is UV or electron beam curable, stabilizing area 206 would subject the coating to UV light or an electron beam. Typically, when the settable coating 204 is cured through the use of one or more chemicals or catalysts, the chemical or catalyst is in the settable coating 204 in the reservoir 202, and an appropriate condition is applied at the stabilizing area 206 in order to effect curing and set the BOAS morphology.

In some embodiments, the settable coating 204 is a solution, and the stabilizing area 206 is an oven that subjects the coating to heat to drive off the solvent. In such embodiments, the may even be at ambient temperature, simply allowing the solvent to evaporate and set the BOAS morphology.

In some embodiments, the settable coating 204 is an amorphous or semi-crystalline material having a reversible glass transition temperature, and the stabilizing area 206 cools or otherwise conditions the coating to bring it below the glass transition temperature to set the BOAS morphology.

While FIG. 3 shows base fiber 12 pulled in a vertical fashion through the coating apparatus 200, it is not imperative that the fiber is pulled vertically to produce a BOAS fiber. In one or more embodiments, the coating apparatus 200 may be configured to pull the base fiber 12 in a vertical direction. In other embodiments, the coating apparatus may be configured to pull the base fiber 12 in a horizontal direction. In other embodiments, the coating apparatus 200 may be configured to pull the base fiber 12 at an angle off of horizontal.

In one or more embodiments, the fiber is pulled from the coating reservoir at a constant speed to produce evenly spaced beads. In one or more embodiments, the fiber is pulled from the coating reservoir at a rate of 1 μm/s to 9 m/s. In other embodiments, the fiber is pulled from the coating reservoir at 1 μm/s to 5 cm/s. In other embodiments, the fiber is pulled from the coating reservoir at 1 μm/s to 100 μm/s.

In one or more embodiments, while the fiber is pulled from the reservoir, the speed at which the fiber is pulled is accelerated or decelerated to produce beads with different sizes and spacing.

While it may be advantageous to produce the fiber through electrospinning, in one or more embodiments, the beads of the BOAS fiber are not produced through electrospinning. In one or more embodiments, the fiber of the BOAS fiber are pre-formed before a coating is applied to the fiber.

As previously mentioned, softer beads may result in advantageous properties such as contact area between a coating and a substrate. Softer beads may be prepared by controlling the degree or amount of curing. In one or more embodiments, the periodically spaced droplets are cured to completion to produce a hard bead structure, completion being from 90% or more to and including 100%. In other embodiments, the periodically spaced droplets may be cured to partial completion to produce a soft bead structure, with partial being below 90%. In one or more embodiments, curing to partial completion may produce beads that are cured to 10%, 20%, 30%, 40%, 50%, 60%, 70%, 80%, or 90% of completion.

In instances where the settable coating is such that it has adhesive properties, it is noted that the adhesive properties are improved in the creation of the BOAS morphology as compare to a similar cylindrically coated fiber having the same volume of coating. This is a general phenomenon of the BOAS morphology taught herein, and is specifically shown in the examples herein. Though the examples are directed to PDMS-coated nylon, it will be appreciated that the adhesion improvement is observed for other coatings with adhesive properties in their stabilized form.

### EXAMPLES

### Preparation of Functional Fibers

Nylon fibers (gifted by Goodyear, Akron, Ohio) of diameter 30 μm were vertically withdrawn, at a controlled velocity, from a reservoir filled with poly(dimethylsiloxane) (PDMS) (equal parts of Sylgard 528A and B provided by Dow Corning). The cylindrical coating of PDMS spontaneously breaks into an array of droplets. The fiber is placed in a vacuum oven at 80° C. for 2 h to cure the PDMS. To show the effect of viscosity on drop dimensions and spacing, un-cross-linked PDMS of kinematic viscosities 10 cst, 100 cst, and 1000 cst (10⁻⁵ m²/sec, 10⁻⁴ m²/sec, and 10⁻³ m²/sec, respectively) were used (Dow Corning).

### Measurement of Adhesion Force

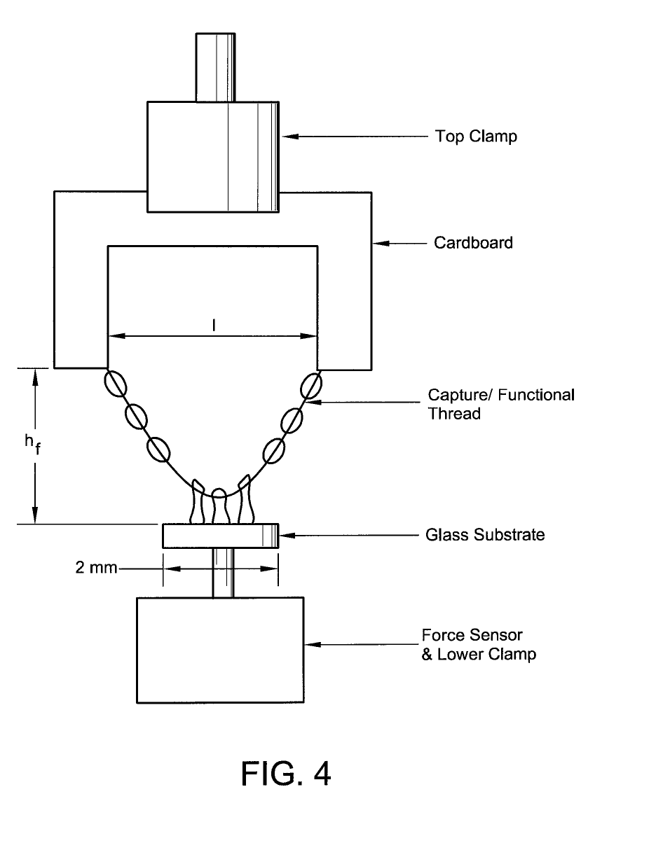

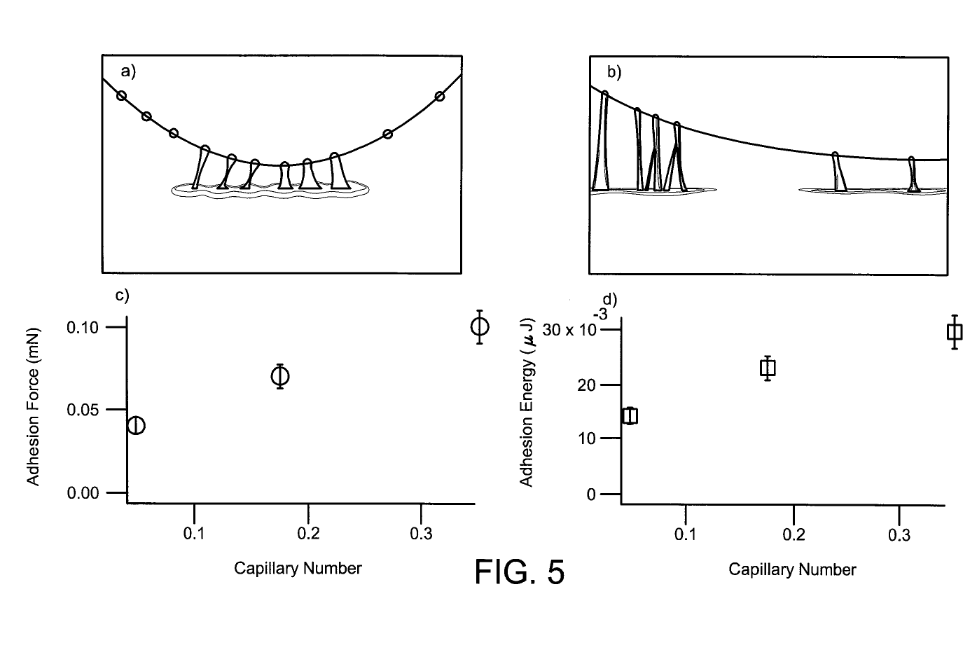

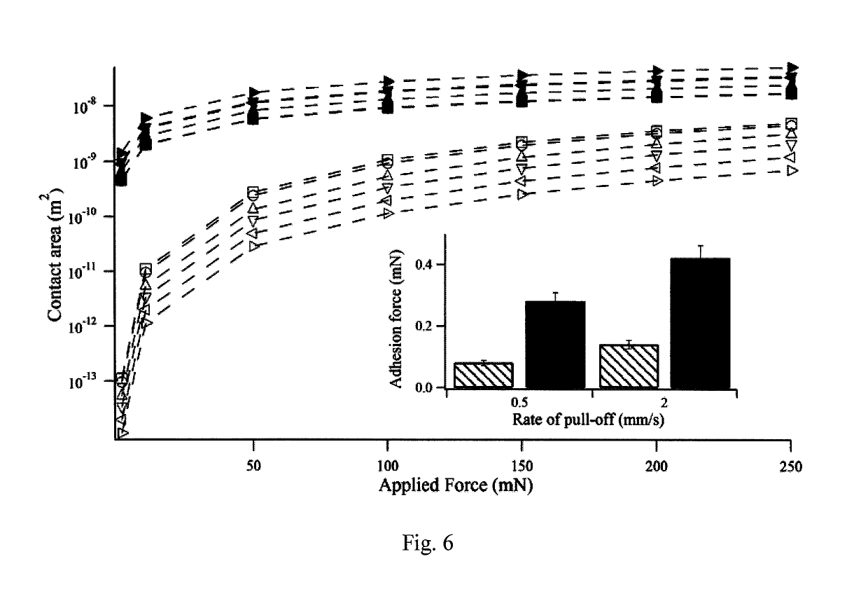

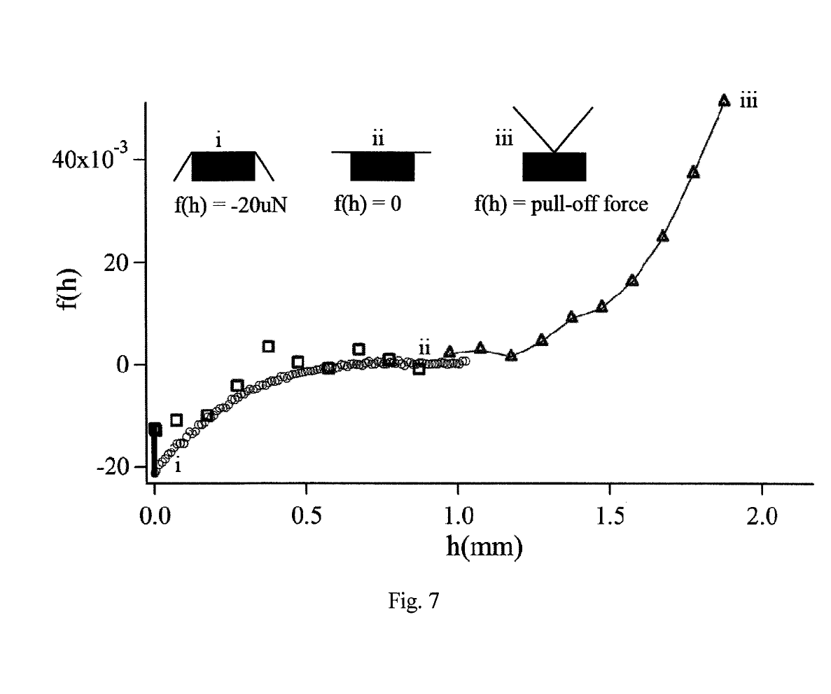

Sixteen-millimeter samples of the cured fibers, mounted across the gap of a U-shaped cardboard piece, were clamped onto the top grip of NanoBionix (Agilent Tech., formerly MTS) as shown in FIG. 4. A 2 mm-wide clean glass plate was clamped onto the bottom grip. The fiber was pushed onto the glass plate to a force of 20 μN at a rate of 0.1 mm s⁻¹ (displacement-controlled loading), held there for 60 s, and then pulled away from the substrate at a fixed rate. This was performed at different pull speeds for different fibers, (2 mm/s for FIG. 5c,d and 0.5 mm/s and 2 mm/s for FIG. 6, inset), while the force displacement response is recorded (FIG. 7). Force is measured by the displacement of the actuating transducer in the NanoBionix. The maximum displacement of the transducer is ±1 mm. The force registered just before the fiber releases contact with the class plate is recorded as the adhesion force. Ten samples were tested three times each. Values are plotted as mean±SD from 30 measurements each.

### Measurement of the Tensile Properties

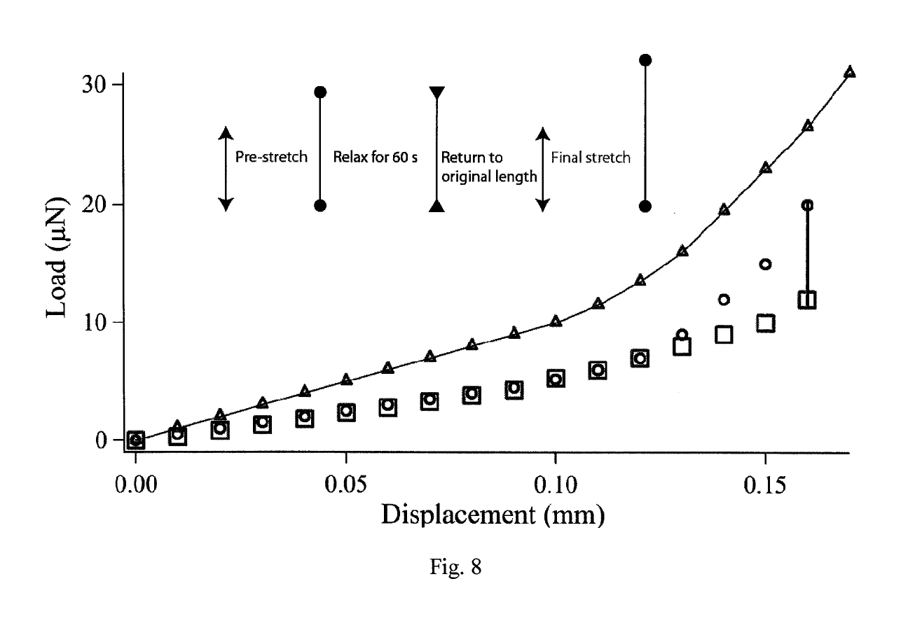

Independent tensile tests on the fibers were performed, by clamping a fiber onto the top and bottom grips of the NanoBionix, to find out the strain energy stored (area under the stress-strain curve) when the fiber is stretched (FIG. 8). The maximum strain to determine the energy stored in the fiber was determined from the maximum strain experienced by the fiber during the adhesion measurements. These tensile tests were performed at the same stretching rates that the fibers experienced during adhesion measurements, to account for any viscoelastic effects. Strain energy values were determined from testing ten 16-mm long fiber samples. The equation used to calculate the contribution of the energy stored in stretching the fiber is discussed in the main text.

### Results and Discussion

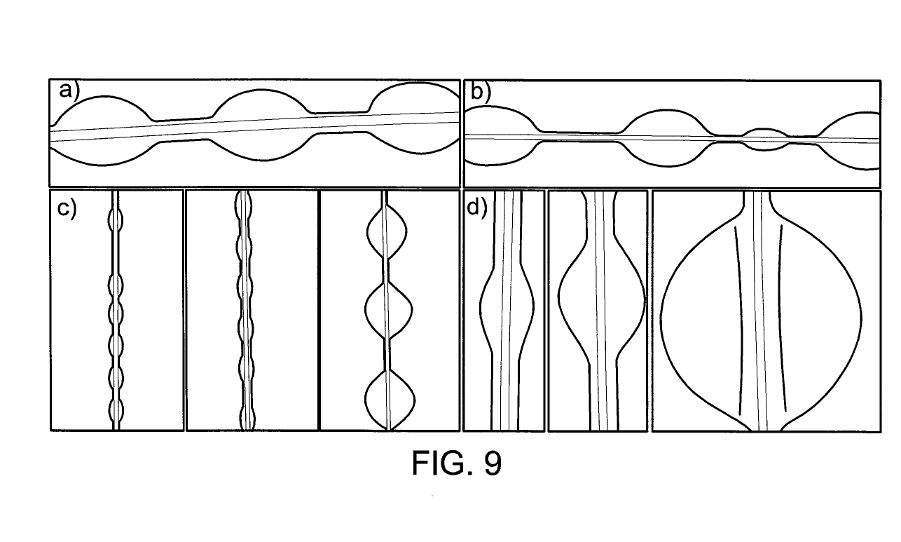

A continuous microfiber (Nylon) is pulled vertically out of a reservoir containing PDMS at different velocities. We choose PDMS as the liquid because it has low surface tension, and the effect of gravity on the droplets is negligible (bond number <<1). Depending on the capillary number, Ca, the cylindrical coating breaks down into an array of droplets due to Rayleigh instability. The coated fiber is then cured by heating at 80° C. to stabilize and immobilize the droplets. FIGS. 9a and b show a capture fiber spun by Argiope trifasciata and functional fibers formed by coating nylon fiber with PDMS.

The adhesion of the fibers can be easily tuned by varying the capillary number. Upon withdrawing a fiber from the reservoir, the thickness of the entrained cylindrical film, e, for bond number <<1 (which is the case here), is given by the following equations:

$$e = \{ \begin{matrix}1.34 {dCa}^{2 / 3} , & Ca ≪ 1 \\ \frac{1.34 {dCa}^{2 / 3}}{1 - 1.34 {Ca}^{2 / 3}} , & Ca \sim 1\end{matrix} \qquad ( 1 )$$

Here, Ca=ηV/γ and d is the radius (of the uncoated fiber), η is the viscosity of the coating, γ is the surface tension of the coating, γ, and V is the velocity at which the fiber is withdrawn from the reservoir (i.e., withdrawn from the coating). Plateau and Rayleigh showed that the initially cylindrical coating breaks into an array of drops such that the wavelength of the array, λ, as well as the radius of the sphere, R, are both dependent on the thickness of the cylindrical coating e.

$$\begin{matrix}λ > 2 π ( d + e ) & ( 2 ) \\ R = {[ \frac{3 λ}{4} ( {( d + e )}^{2} - {d}^{2} ) ]}^{1 / 3} & ( 3 )\end{matrix}$$

In essence, by varying η, γ, or V, one can change Ca. Changing Ca will change the thickness of the coating and hence the radius of the cylinder, which will determine the wavelength λ of the array of spheres of radius R. Using this principle, the size and spacing of the drops on the functional fibers were tuned by varying the capillary number. FIG. 9c shows the effect of velocity, V, on the size and the spacing of the drops. The volume of the drop as well as the spacing between the droplets increases with increasing velocity of the coating. FIG. 9d shows the effect of viscosity, η, of the coating on the volume and the wavelength of the droplets. Similar to the velocity, increasing the viscosity also results in higher drop volume and longer wavelength.

The modern orb-weavers have developed an intriguing structure for their capture fibers, utilizing glue droplets as adhesive beads on a very elastic silk fiber. The glue droplets behave like viscoelastic solids and can withstand large extension as shown in FIG. 5a. The “suspension bridge”-like structure increases the peeling force and makes the capture fibers very sticky. This was one of the reasons PDMS was chosen as the fluid to mimic this morphology, as cross-linked PDMS is elastic and stretchy. FIG. 5b shows an optical image of the functional fiber as it is pulled off the surface. Similar to the capture silk threads produced by spiders, a suspension bridge-like structure is observed in the functional fiber. The adhesion forces required to peel the functional fibers are shown in FIG. 5c. Higher capillary number was accompanied by higher force of adhesion. Interestingly, capture silk threads spun by different orb-weaving spiders also show similar behavior: generally, capture threads with bigger and farther-spaced drops demonstrate higher adhesion.

It has been shown that the force of adhesion depends on the mechanical properties of both the fiber and the glue droplets. The contributions from the fiber and the glue can be separated by using a recently developed energy model. The work performed to pull a fiber off a surface is consumed in stretching of the axial fiber and the energy required to peel the droplets from the surface. FIG. 4 shows a sketch defining the variables used in the energy model. The total work on the system (W_{T}) is calculated by integrating the product of the force f(h) times the infinitesimal height change dh from h to h+dh.

W_{T}=∫₍ₕ₌₀₎^{(h=h}^{_{f}}⁾f(h)dh (4)

The strain energy stored in the fiber when it is pulled from its initial position until it separates from the surface, Uₛₜᵣₐᵢₙ, is given by the following equation:

Uₛₜᵣₐᵢₙ=∫_{(c=0)}^{(ε=ε}^{_{f}}⁾σ(ε)dε (5)

σ(ε) is the value of load at displacement ε, as measured from independent tensile tests. Here, the assumption is that the length of fiber adhered to the substrate at any time during the adhesion measurement is negligible compared to the total length of the fiber, which is reasonable since the width of the substrate (2 mm) is much less than the length of the fiber (16 mm) Subtracting equation (5) from equation (4) gives the energy required to separate the glue drops from the surface, U_{glue}. FIG. 5d shows the energy of adhesion of the glue drops as a function of the capillary number. The increase in the energy of adhesion of the glue drops with increasing capillary number, indicating that the increase in force of adhesion is due to the glue drops and not to the difference in tensile properties of the fiber. The extent of functionality (adhesiveness in this case) imparted to a fiber can thus be easily tuned by varying the capillary number.

Interestingly, when a newly spun capture silk fiber (the glue coating is still cylindrical) spun by Larinioides cornutus is brought into contact with a clean glass plate and then separated from it, the force of adhesion measured at separation is around 3 times lower than when the glue coating has broken into an array of droplets (FIG. 6, inset). The difference in adhesive forces can be attributed to higher contact area established by the glue droplets than the glue cylindrical morphology and the higher energy dissipated in separating the glue droplets than in separating the glue cylinder, since peeling glue droplets from a surface will have multiple crack-initiation, crack-propagation, and crack-arrest events, whereas peeling a cylinder will require only one of each. Using the functional fibers as an example, we studied the effect of these factors (interfacial contact area established and energy dissipation during separation) on the adhesion of both morphologies (cylinders and spheres) in an attempt to understand the advantage of the BOAS morphology on the capture silk fibers.

Considering a linear elastic model, the differences in contact areas between the BOAS morphology and the cylindrical coating of similar volume (mimicking insect capture)can be calculated. For the sake of simplicity, it can be assumed that the glue drops are spherical. (In reality, the glue drops produced by spiders are paraboloidal.) According to the Johnson-Kendall-Roberts (JKR) theory, the contact radius, a, of the circle formed by pressing a deformable sphere onto a rigid flat surface is given by

$${a}^{3} = \frac{R}{K} ( P + 3 π WR + \sqrt{( 6 π WRP + {( 3 π WR )}^{2} )} ) \qquad ( 6 )$$

In the JKR model, P is the applied load, R is the radius of curvature of the sphere, W is the adhesion energy of the sphere with the substrate, and K is related to the effective elastic modulus (E_{eff}, K=4E_{eff}/3). In the case of the cylindrical fiber, a contact rectangle of length, 2l, and width, 2b, is formed upon pressing a deformable cylinder on a rigid flat surface and is given by

$$\frac{3 π}{8} \frac{\text{?}}{S} = \frac{P}{\text{?}} + \sqrt{\frac{6 π W}{K}} \\ \text{?} \text{indicates text missing or illegible when filed} \qquad ( 7 )$$

Here, S is the radius of the cylinder, and other terms are similar to those described in equation (5). FIG. 6 compares the interfacial area, calculated assuming JKR contact, established by a cylinder and the eventually formed spheres, with a rigid flat substrate. Since the cylinder breaks into an array of spheres, the volume of the sphere is equal to the volume of one wavelength of cylinder. For the same loading force, a sphere establishes higher contact area than a cylinder of equal volume (FIG. 6). The glue coatings produced by orb-weaving spiders, as well as the cross-linked PDMS coating on the functional fibers, exhibit elasticity, and the elastic model in these calculations is used to illustrate that the sphere geometry (BOAS fibers) results in higher contact area with the substrate.

In addition to the higher surface area established by the array of spheres, the BOAS morphology adopted by spiders also has a higher force required to separate the array of spheres from a surface (mimicking insect rescue). The higher separation force is due to the multiple crack-initiation, crack propagation, and crack-arrest events as opposed to a single event when a cylinder is separated from a surface. Kendall has showed that different interfaces between materials of different thicknesses have a considerable effect on crack propagation: when a crack meets a thicker material, it experiences transient retardation, whereas when a crack meets a thinner material, it experiences transient acceleration. Hence, periodic structures (like spider capture silk threads and functional fibers) substantially increase static interfacial fracture energy through arresting cracks at a thicker interface. Moreover, the dynamic interfacial fracture energy, i.e., resistance to a moving crack, is also raised due to fluctuations of crack speed at a number of periodically spaced interfaces. Kendall's analysis on peeling tapes suggests that the spacing and diameter of the glue drops are important in increasing the peeling force. We illustrated the importance of this hypothesis by referring to the works of Ghatak and Chaudhury. For the sake of simplicity, the array of drops can be roughly approximated as a one-dimensional adhesive film having equi-spaced incisions on it (distance between incisions=s). For separating a smooth surface of a finite flexural rigidity D, the stress decay length, κ⁻¹, is given by

$${κ}^{- 1} = {( \frac{{Dw}^{3}}{12 μ} )}^{1 / 6} \qquad ( 8 )$$

Here, D=0.02 N·m, μ=1 MPa, and w was taken to equal the width of a single glue droplet, while s was taken as the wavelength of the droplets (details in the Supporting Information). For the dimension of the array shown in FIG. 6, sκ (a dimensionless parameter defined by Chaudhury, M. K.; Weaver, T.; Hui, C. Y.; Kramer, E. J., J. Appl. Phys. 1996, 80, 30, which describes the thickness and the wavelength of the array), for the array of beads varies from 0.3 to 1.3, while separating a cylinder from the same surface would have sκ=∞. It has been shown that energy required to separate the film reduces as sκ increases, which implies that the energy required to separate a BOAS fiber will be higher than that required to separate a cylindrical fiber. Higher energy dissipated while separating a BOAS fiber, together with the higher interfacial surface area established by the BOAS morphology demonstrates that the BOAS structure exhibits higher adhesion than the cylindrical structure.

In summary, we have mimicked the strategy used by orb-weavers to develop functional microfibers with excellent adhesive properties. By varying the capillary number, the structure and morphology of the functional fibers can be controlled. The simplicity and scalability of this method over conventional methods used to produce such structures—template-based synthesis, vapor-phase synthesis, solution-phase deposition, and coaxial electrospinning—allows rapid and easy large-scale fabrication of one-dimensional BOAS structures with a wide range of compatible component materials. The BOAS structure establishes higher interfacial contact area than a cylindrical morphology for the same applied load. Also, the energy required to separate a BOAS fiber is higher on account of multiple crack-initiation, crack-propagation, and crack-arrest events. These results demonstrate that the BOAS structure has higher adhesion than a cylindrical morphology, which may explain why the BOAS morphology is seen in multiple species of spider and over evolutionary history.

In light of the foregoing, it should be appreciated that the present invention significantly advances the art by providing BOAS fibers and processes for making the same. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A method of preparing a fiber with periodically spaced beads comprising:
coating a base fiber with a settable coating;
thereafter allowing the settable coating to form periodically spaced beads on the base fiber through Rayleigh instability; and
stabilizing the periodically spaced beads into periodically spaced beads thus creating a fiber with beads-on-a-string morphology.

2. The method of claim 1, where either the base fiber or the settable coating is non-proteinaceous.

3. The method of claim 1, wherein the settable coating is selected from coatings that are stabilized through curing, coatings that are stabilized through drying, and coatings that are stabilized through cooling.

4. The method of claim 3, wherein the settable coating is a coating that is stabilized through curing, and said step of stabilizing includes at least partially curing said settable coating.

5. The method of claim 4, wherein the settable coating is selected from coatings that are UV curable, coatings that are heat curable, coatings that are electron beam curable and coatings that are curable through use of one or more chemicals or catalysts.

6. The method of claim 3, wherein said settable coating is a coating that is stabilized through drying, and said step of stabilizing includes drying said settable coating.

7. The method of claim 6, wherein said settable coating is a solvent/solute system, and said step of stabilizing includes evaporating the solvent to stabilize the settable coating.

8. The method of claim 3, wherein the settable coating is a coating that is stabilized through cooling, and said step of stabilizing includes cooling said settable coating.

9. The method of claim 8, wherein said settable coating is an amorphous or semi-crystalline material having a reversible glass transition temperature, and said step of stabilizing includes reducing the temperature of the settable coating below the glass transition temperature.

10. The method of claim 1, wherein said step of coating a base fiber includes drawing the base fiber out of a bulk source of settable coating at a velocity, V.

11. The method of claim 10, wherein the settable coating includes a viscosity, η, and a surface tension, γ, wherein a capillary number, Ca is calculated according to Ca=ηV/γ.

12. The method of claim 11, wherein the velocity, V, of said step of coating and the settable coating are chosen such that Ca is approximately 1.

13. The method of claim 11, wherein the velocity, V, of said step of coating and the settable coating are chosen such that Ca is greater than 0.64.

14. The method of claim 11, wherein the velocity, V, of said step of coating and the settable coating are chosen such that Ca is equal to or less than 0.64.

15. The method of claim 11, wherein, in said step of coating, the settable coating forms an initially cylindrical coating on the base fiber, and wherein the size and spacing of the periodically spaced beads that form in said step of allowing are determined according to the following formulae:
$$\begin{matrix}e = \{ \begin{matrix}1.34 {dCa}^{2 / 3} , & Ca ≪ 1 \\ \frac{1.34 {dCa}^{2 / 3}}{1 - 1.34 {Ca}^{2 / 3}} , & Ca \sim 1 ,\end{matrix} & ( 1 ) \\ λ > 2 π ( d + e ) , \\ and & ( 2 ) \\ R = {[ \frac{3 λ}{4} ( {( d + e )}^{2} - {d}^{2} ) ]}^{1 / 3} & ( 3 )\end{matrix}$$
wherein d is the radius of the base fiber, e is the thickness of the initially cylindrical coating on the base fiber and R is the radius of the beads and λ is the wavelength of the periodically spaced beads, Ca<<1 is to be understood as indicating that Ca is equal to or less than 0.64 and Ca≈1 is Ca greater than 0.64.

16. The method of claim 1, wherein the settable coating has a bond number of less than 1.
